(19) United States
(12) Patent Application Publication
(10) Pub. No.: US 2020/0147855 A1
(43) Pub. Date: May 14, 2020

(54) INJECTION BLOW MOLDING SYSTEM AND METHOD

(71) Applicant: Plastipak Packaging, Inc., Plymouth, MI (US)

(72) Inventors: Marc A. Pedmo, Litchfield, OH (US); Andrew Fischer, Medina, OH (US); Michael J. Sainato, Wadsworth, OH (US); David Greig, Massillon, OH (US); Matt Kinkoph, Lagrange, OH (US); Richard C. Darr, Medina, OH (US)

(21) Appl. No.: 16/680,582

(22) Filed: Nov. 12, 2019

Related U.S. Application Data
(60) Provisional application No. 62/758,784, filed on Nov. 12, 2018.

(51) Int. Cl. B29C 49/48; B29C 49/06

(52) U.S. Cl. CPC B29C 49/48; B29L 2031/7158; B29C 49/06

(57) ABSTRACT

An injection blow molding system including a core pin, a neck ring, and a blow mold. The injection blow system may be configured to form a preform on the core pin and to blow mold the formed preform on the core pin to form a container. In an embodiment, the core pin includes a poppet that is configured to be disposed in a retracted configuration and an extended configuration. A method for forming a preform and container on a core pin is also disclosed.

### CROSS-REFERENCE TO RELATED APPLICATION

This application claims the benefit of priority to U.S. Provisional Application No. 62/758,784, filed Nov. 12, 2018, the entire disclosure of which is incorporated herein by reference.

### TECHNICAL FIELD

The present disclosure generally relates to injection blow molding, including injection blow molding systems and methods for forming plastic containers.

### BACKGROUND

This background description is set forth below for the purpose of providing context only. Therefore, any aspect of this background description, to the extent that it does not otherwise qualify as prior art, is neither expressly nor impliedly admitted as prior art against the instant disclosure.

Conventional injection blow molding machines typically are indexing in nature. With such indexing machines, preforms and bottles are produced on a common core pin. However, there are multiple sets of core pins that index from an injection stage, to a blowing stage, to an eject stage, and sometimes to a fourth stage that may further condition the then-empty core pins.

There is a desire for solutions/options that, among other things, can adapt to existing injection tooling and reduce or minimize tooling size, while enabling use on optimized tooling cavitation. The foregoing discussion is intended only to illustrate examples of the present field and should not be taken as a disavowal of scope.

### SUMMARY

An injection blow molding system including a core pin, a neck ring, and a blow mold. The injection blow system may be configured to form a preform on the core pin and to blow mold the formed preform on the core pin to form a container. In an embodiment, the core pin includes a poppet that is configured to be disposed in a retracted configuration and an extended configuration. A method for forming a preform and container on a core pin is also disclosed.

The foregoing and other aspects, features, details, utilities, and/or advantages of embodiments of the present disclosure will be apparent from reading the following description, and from reviewing the accompanying drawings.

### BRIEF DESCRIPTION OF THE DRAWINGS

FIG. 1 is a cross-sectional side view generally illustrating an embodiment of a core pin according to aspects and/or teachings of the present disclosure, shown with a poppet in a retracted position.

FIG. 2 is a cross-sectional side view generally illustrating an embodiment of a core pin according to aspects and/or teachings of the present disclosure, shown with a poppet in an extended position.

FIG. 3 is a cross-sectional side view generally illustrating an embodiment of an injection blow molding system according to aspects and/or teachings of the present disclosure.

FIG. 4 is a perspective view of the embodiment of a core pin according to aspects and/or teachings of the present disclosure.

FIG. 5 is a side view representation of a portion of an injection blow molding system, including a neck ring.

FIG. 6 is a cross-sectional perspective view of a core pin and neck ring.

FIG. 7 is a transparent perspective view of a core pin.

FIG. 8 is a cross-sectional perspective view of a core pin and neck ring,

FIG. 9 is a cross-sectional perspective view of a core pin and neck ring.

FIGS. 10-16 generally provide perspective views in partial cross-section that illustrate an embodiment of a method according to aspects and/or teachings of the present disclosure.

### DETAILED DESCRIPTION

Reference will now be made in detail to embodiments of the present disclosure, examples of which are described herein and illustrated in the accompanying drawings. While the present disclosure will be described in conjunction with embodiments and/or examples, it will be understood that they are not intended to limit the present disclosure to these embodiments and/or examples. On the contrary, the present disclosure is intended to cover alternatives, modifications, and equivalents.

In an embodiment of an injection blow molding system, a press (e.g., a horizontal press) with one or more core pins is provided. Such a press may be configured to both (a) injection mold a preform (or intermediate article) and (b) form a resulting container. In embodiments, a preform and a resulting container (i.e., formed from the preform) remain on the same core pin for both the injection and container formation process. With embodiments, a preform may be injection molded and may be maintained at an elevated temperature to help to facilitate subsequent blow molding. Consequently, an intermediate reheating process may not be necessary. The core pin may be configured so that pressurized air can travel through the core pin and blow mold the preform to form a resultant plastic container.

The plastic container may be comprised of a polymer, including one or more polymers. In embodiments, the plastic container may be comprised of polyethylene terephthalate (PET), including various forms (e.g., virgin or recycled) or blends thereof.

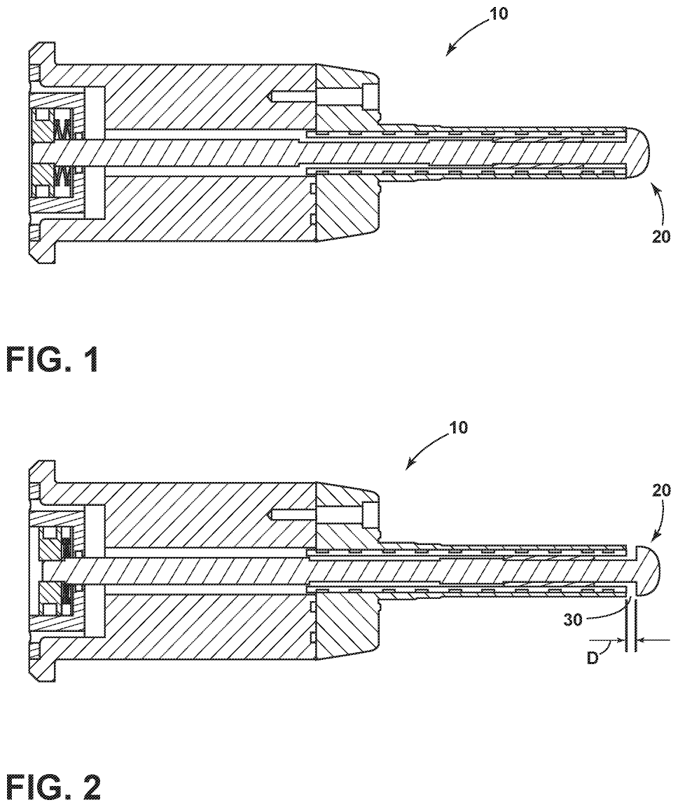

FIGS. 1 and 2 generally illustrate an embodiment of a core pin 10 that may employ aspects or teachings of the present concept. FIG. 1 generally illustrates a poppet 20 in a retracted configuration (such as during an injection phase). FIG. 2 generally illustrates poppet 20 in an extended configuration (such as during a blowing phase). As shown in FIG. 2, an end of poppet 20 may extend some distance D from an end of a pin wall 30, which can form a space or void and permit the core pin 10 to provide a gas (e.g., pressurized air) to mold a preform. In embodiments, the distance D may be selectively controlled, and may in turn provide flow adjustment.

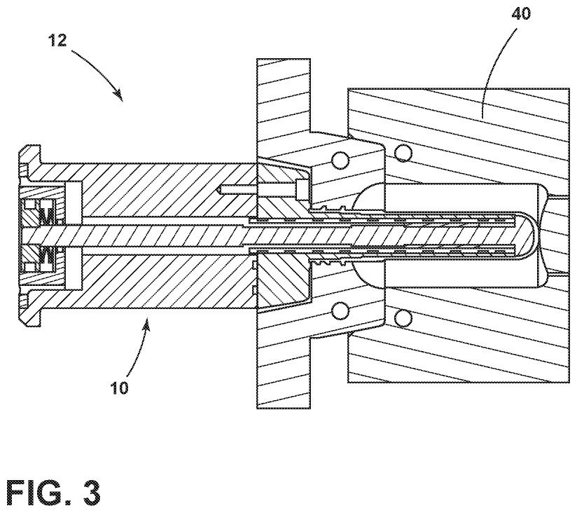

FIG. 3 generally illustrates a cross-sectional view of a core pin 10 in connection with a blow mold 40 in connection with a blowing phase. In an embodiment, the blow mold 40 may formed from two or more mold portions (e.g., mold halves). However, in another embodiment, the mold may be unitary (i.e., formed as a monolithic or a one-piece, solid component).

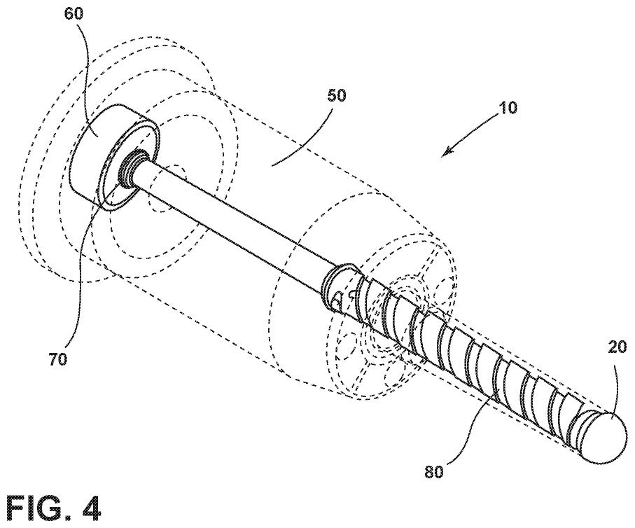

An embodiment of a core pin 10 is generally illustrated in FIG. 4. As shown, the core pin 10 may include, inter alia, one or more of the following components/features: a main body 50, an internal poppet 20, a piston 60, a poppet return spring 70, and a cooling water circuit 80. With such an embodiment, a piston 60 can be connected to a poppet 20. Air pressure may be applied to piston 60 and can extend the poppet 20 (e.g., in one circuit). In a separate air circuit, air may travel through a void (e.g., a space associated with distance D in FIG. 2) and may blow a container. As generally illustrated, a core pin 10 may include a cooling water circuit 80, which may be similar to a preform cooling tube. Such a cooling water circuit can provide cooling effect in a relatively small area. In embodiments, the cooling water circuit 80 may spiral around a longitudinal length of the core pin 10 and/or at least extend along a portion of the core pin 10 in proximity to the poppet 20.

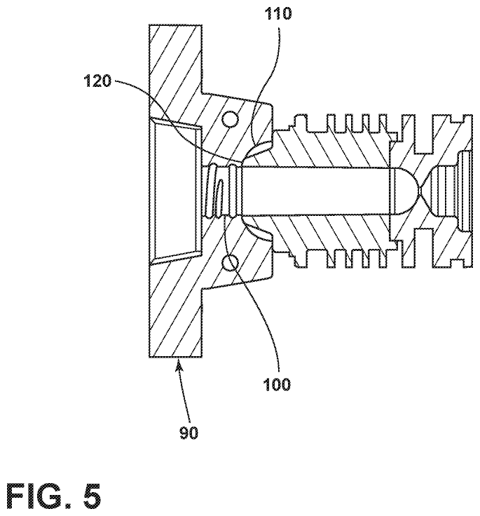

With reference to FIG. 5, a neck ring 90 may engage or contain a finish molding surface 100 of the associated preform formed during the injection phase. The neck ring 90 may also include a shoulder molding surface 110. In embodiments, the shoulder molding surface 110 may form a shoulder and/or a widest outer diameter of a container formed during a blowing or blow molding phase. A configuration with a neck ring 90, such as generally illustrated, can facilitate retraction of a resulting blown container from the blow mold via the neck ring 90. Moreover, with embodiments of the present disclosure, a neck ring 90 may be used to both mold a preform finish and to form a portion of the container during the blow molding portion of the process. Additionally, a mouth of an injection cavity may be configured to include a shutoff 120 for shutting off on the shoulder portion of the neck ring 90.

For embodiments, controlling the temperature of both the injection tooling and the preform can be used to improve efficiency and/or repeatability. Sensors and/or feedback controls may be included to accurately measure and maintain such temperatures at desired or optimized levels. Cycle time may also be controlled.

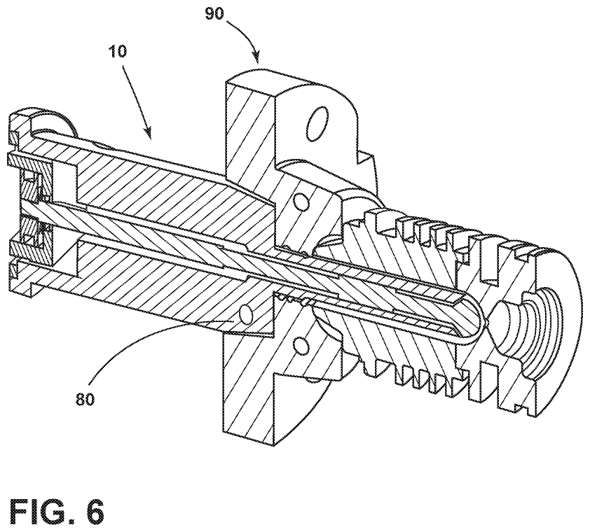

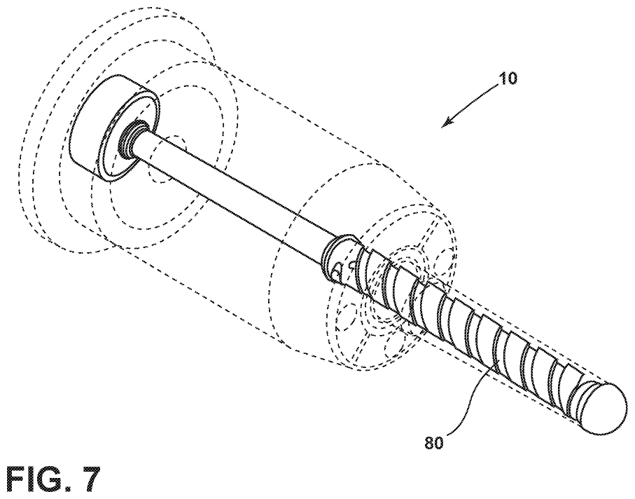

FIG. 6 generally illustrates an embodiment of a core pin 10 and a neck ring 90 with core pin base cooling—e.g., via a cooling water circuit 80. FIG. 7 generally illustrates an embodiment of a core pin 10 having an embodiment of a cooling water circuit 80 further illustrated.

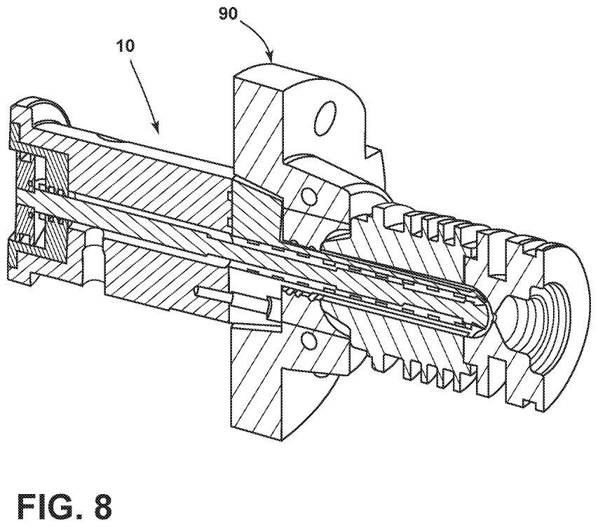

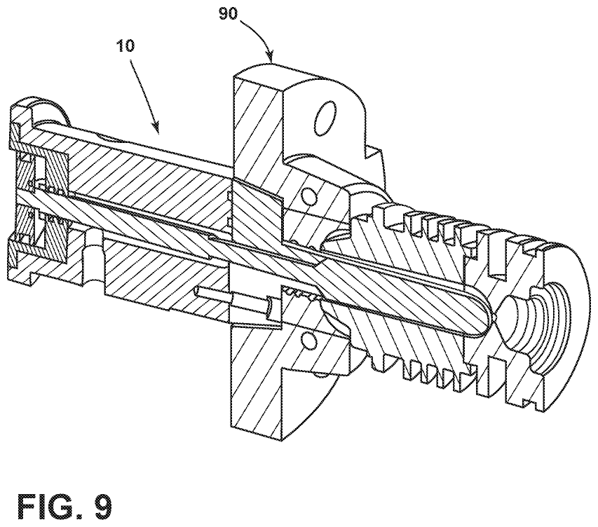

FIG. 8 generally illustrates an embodiment of a reduced poppet, and FIG. 9 generally illustrates an air split near neck tooling configuration.

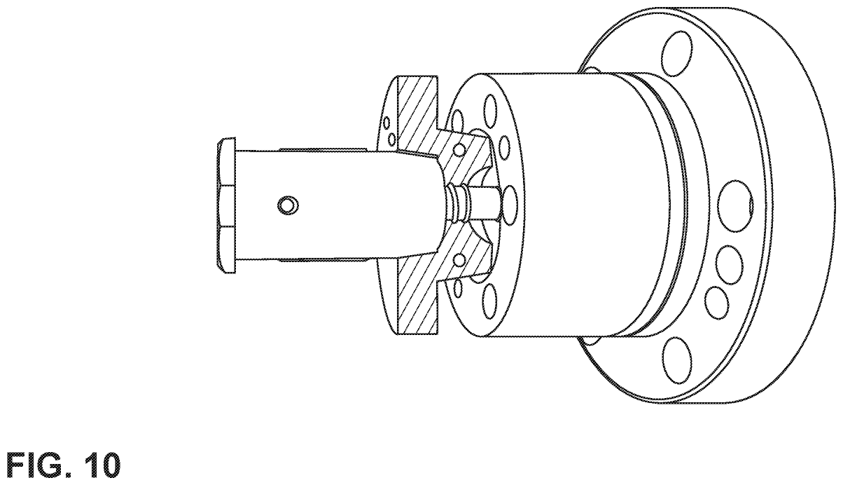

A method for forming a preform and a resulting container is also disclosed. Without limitation as to the specific components and configurations, an embodiment of a method is generally illustrated in connection with FIGS. 10-16.

In a first depicted step (e.g., FIG. 10), an injection mold closes around a core pin and a preform is injection molded.

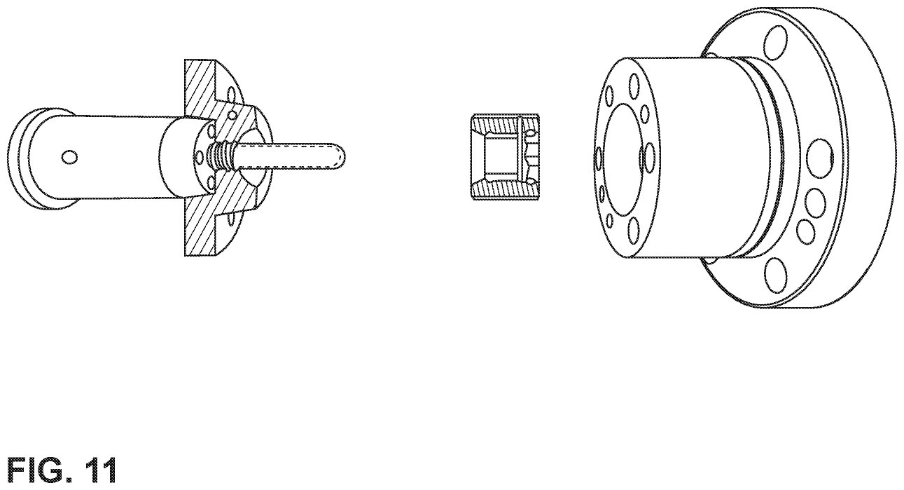

In a subsequent step (e.g., FIG. 11), the injection mold opens, and the then-formed preform remains on the core pin.

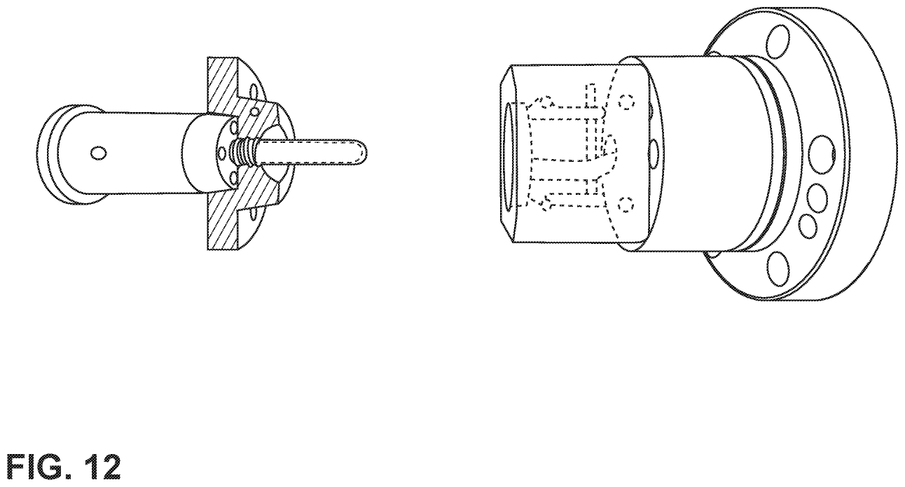

In a subsequent step (e.g., FIG. 12), a blow mold is set up to move onto a centerline between mold halves (e.g., cold and hot halves) of an injection mold.

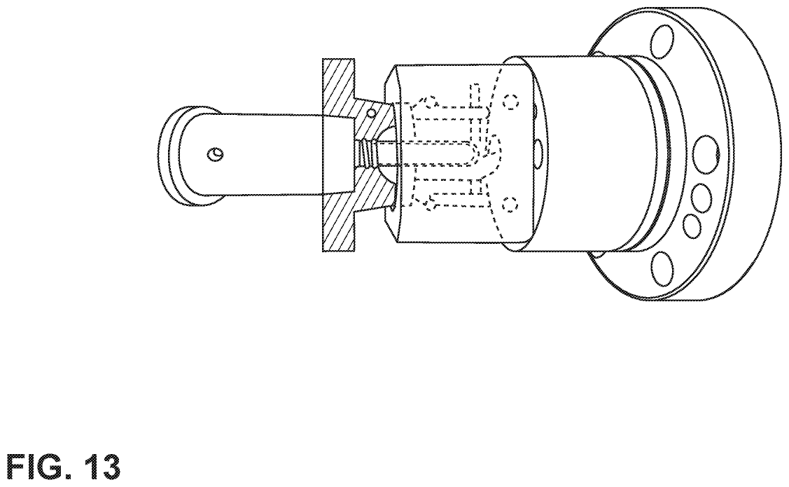

In a subsequent step (e.g., FIG. 13), a mold half (e.g., a cold half with core pin and neck ring with preform) closes on a blow mold.

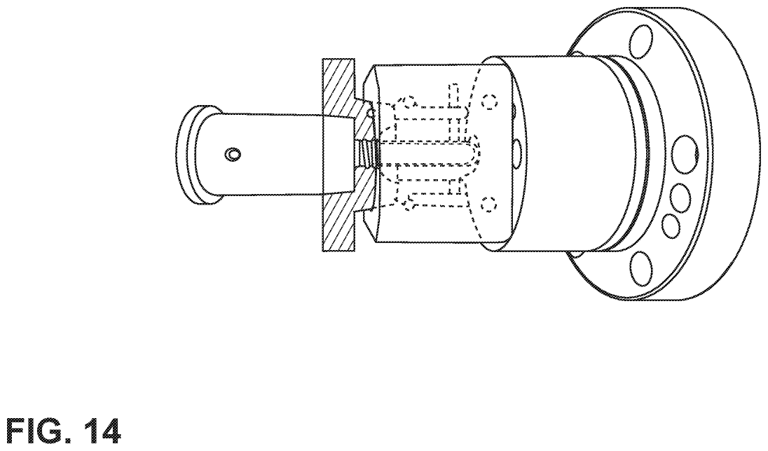

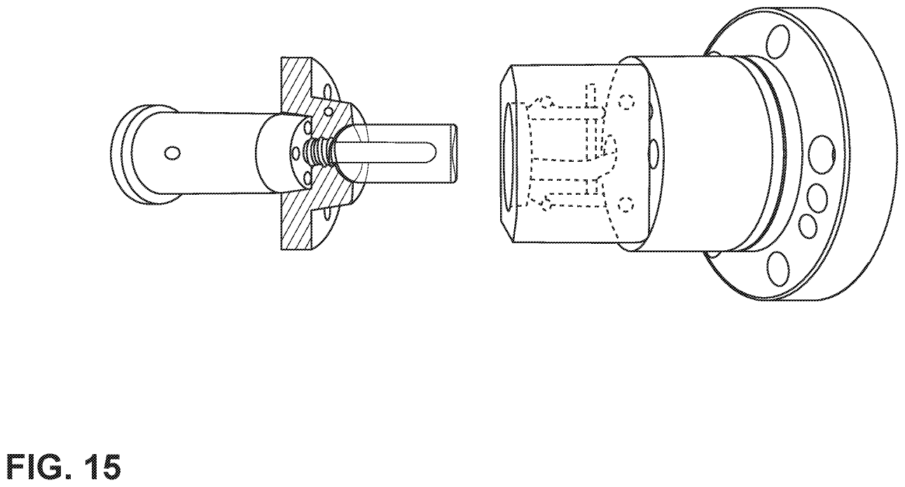

In a subsequent step (e.g., FIG. 14), the core pin poppet opens, air (which may be low pressure air) is blown through the core pin, and a container is formed in the blow mold.

In a subsequent step (e.g., FIG. 15), the mold half (e.g., cold half) retracts, and the blow mold retracts.

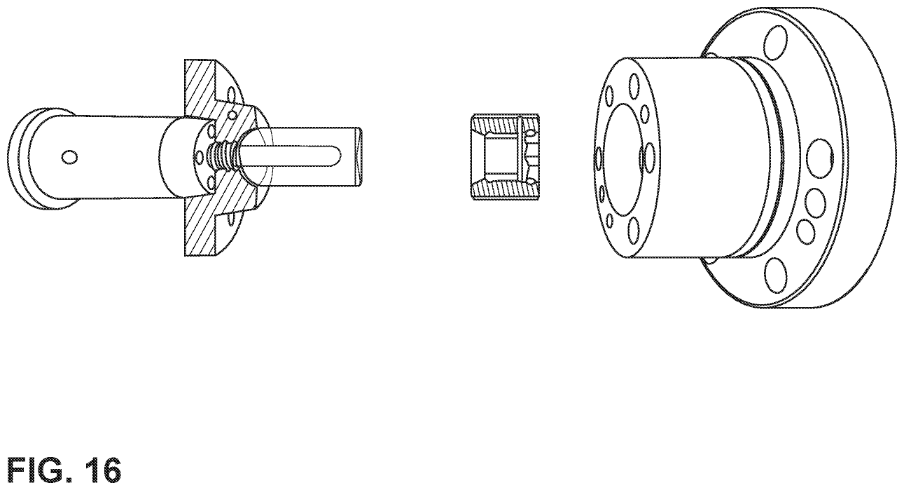

In a further subsequent step (e.g., FIG. 16), the blown container is ejected.

In some embodiments following the ejection of a blown container, the then-empty core pin may be further treated or conditioned.

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are intended to be inclusive unless such a construction would be illogical.

While examples of dimensions of certain components may be described herein, such dimensions are provided as non-limiting examples and the components may have other dimensions.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

It is intended that all matter contained in the above description or shown in the accompanying drawings shall be interpreted as illustrative only and not limiting. Changes in detail or structure may be made without departing from the present disclosure.

What is claimed is:

1. An injection blow molding system comprising:
a core pin including a poppet;
a neck ring; and
a blow mold;
wherein the poppet may be disposed in a retracted configuration and an extended configuration; and the injection blow molding system is configured to form a preform on the core pin and to blow mold the formed preform on the core pin.

2. The injection blow molding system of claim 1, wherein the blow mold comprises at least two mold halves.

3. The injection blow molding system of claim 1, wherein the blow mold comprises a monolithic mold.

4. The injection blow molding system of claim 1, wherein the neck ring is configured to form a finish for the preform during an injection phase.

5. The injection blow molding system of claim 4, wherein the neck ring includes a molding surface configured to form a shoulder or widest outer diameter of a container blown from the preform.

6. The injection blow molding system of claim 4, wherein the neck ring includes a molding surface configured to form a shoulder or widest outer diameter of a container formed from the preform.

7. The injection blow molding system of claim 1, wherein the core pin includes a cooling water circuit.

8. The injection blow molding system of claim 7, wherein the cooling water circuit is at least partially configured in a spiral arrangement around a longitudinal length of the core pin.

9. The injection blow molding system of claim 7, wherein the cooling water circuit extends along a portion of the core pin in proximity to the poppet.

10. A method for forming a preform and container on a common core pin, the method comprising:
closing an injection mold around a core pin;
injection molding a preform;
opening the injection mold, and retaining the preform on the core pin;
enclosing the preform in a blow mold;
blow molding the preform to form said container.

11. The method of claim 10, including moving the blow mold onto a centerline between a cold half and a hot half of the injection mold.

12. The method of claim 11, wherein the cold half retains the core pin and a neck ring of the injection molded preform.

13. The method of claim 11, wherein the core pin includes a poppet that has an open and a closed configuration.

14. The method of claim 13, wherein the poppet is provided in an open configuration in the blow mold.

15. The method of claim 14, wherein, in the open configuration, a gas or air is provided to form said container.

16. The method of claim 11, wherein when the cold half retracts, the blow mold retracts.

17. The method of claim 10, including ejecting the container.

18. The method of claim 10, including treating or conditioning the core pin after a container formed on the core pin is removed or ejected.
